(19) United States
(12) Patent Application Publication
(10) Pub. No.: US 2019/0257144 A1
(43) Pub. Date: Aug. 22, 2019

(54) INSULATED GLAZING WITH INTEGRATED BLINDS

(71) Applicant: ES BLINDS B.V., Eindhoven (NL)

(72) Inventors: Engel Adrianus VAN KAMPEN, Zuidland (NL); Hermannus Johannes Maria VERBEEK, Mierlo (NL); Roald Richard Josephus VANDEPOEL, Eefde (NL); Marius Leonardus Robertus VAN DER LINDEN, Berkel en Rodenrijs (NL)

(73) Assignee: ES Blinds B.V., Eindhoven (NL)

(21) Appl. No.: 16/332,888

(22) PCT Filed: Sep. 18, 2017
(86) PCT No.: PCT/NL2017/050614

§ 371 Date: Mar. 13, 2019

(30) Foreign Application Priority Data
Sep. 16, 2016 (NL) 2017479

(51) Int. Cl. E06B 9/264; G02B 26/02

(52) U.S. Cl. CPC E06B 9/264; E06B 2009/2464; G02B 26/023

(57) ABSTRACT

Insulated glazing panels with integrated blinds. The insulated glazing panels comprise a first body covered by a first low-e coating, and a second body covered by a second low-e coating. A plurality of strips is hingedly arranged between the first and second bodies. By applying a voltage between the low-e coatings, that act as electrodes, the strips can be oriented relative to the bodies to change the translucence and/or color of the panel. The use of the low-e coatings allows a simple connection from the outside to the electrodes in the airtight cavity.

The present invention relates to insulated glazing. More in particular, the invention relates to insulated glazing with integrated blinds and to a method of making the same.

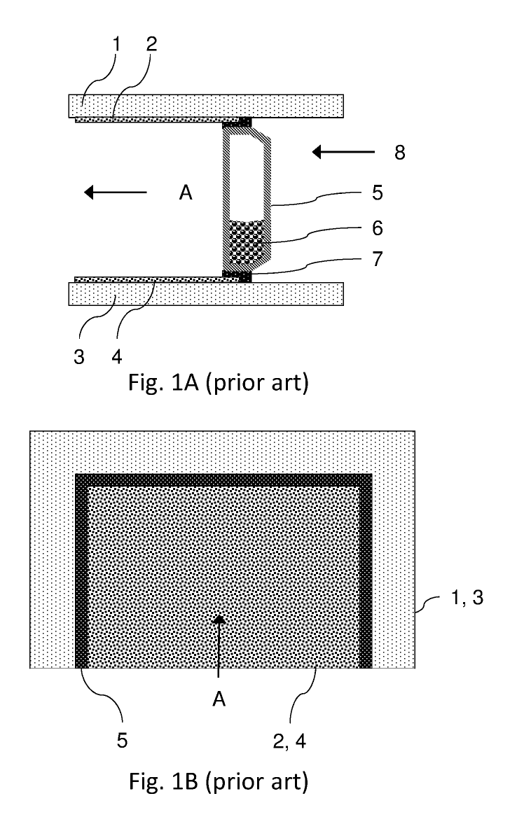

Insulated glazing is well known in the art. A typical insulated glazing panel is illustrated in FIGS. 1A and 1B. It comprises a first substrate having a first glass body 1 and a low emissivity (low-e) coating 2 covering body 1. On an opposite side, a second substrate is arranged that comprises a second glass body 3 and a low emissivity coating 4 covering body 3.

Generally, two different kinds of low-e coatings exist today. A first kind of low-e coating is fabricated using a chemical vapor deposition process, which is applied directly on the floatline to produce a transparent tin oxide layer. Such coating is referred to as a hard coating as it is covalently bonded to the glass. This coating is realized during the manufacturing of the glass bodies 1, 3.

A second kind of low-e coating is fabricated using magnetron sputtered vacuum deposition to produce a transparent metallic coating on the glass body. Such coating is typically referred to as soft coating. This coating is realized after glass bodies 1, 3 have been manufactured. In FIG. 1A, coatings 2, 4 are of the soft coating type.

Soft coatings differentiate from hard coatings in that they show a higher reflectivity for low wavelength infrared radiation, which is typically associated with sunlight. Both coatings show a high reflectivity for high wavelength infrared radiation, which is typically associated with a heated environment or objects. As such, hard coatings are used more often in relatively cold climates, where it is important to use the thermal energy from the Sun to heat up a home and to limit the thermal energy from inside the house to escape via radiation through the window.

Soft coatings are more often used in relatively warm climates, where it is important, in the summer time, to maintain cool temperatures inside the house by blocking the thermal radiation from the outside and the Sun. In the winter-time, the same insulated panel prevents the loss of thermal energy from inside the house to escape via radiation through the window.

The cross section illustrated in FIG. 1A and the top view in FIG. 1B illustrate that at the edge of the panel a spacer frame 5 is arranged in between the two substrates. Spacer frame 5 is typically filled with a desiccant 6 and is fixed to the two substrates using a sealant 7. The interior of the panel, indicated by arrow A, is an airtight cavity that is typically filed with an inert gas, such as Argon. To achieve sufficient constructional strength of the glass panel, kit or another adhesive 8, located outside the cavity, is used to fix glass bodies 1, 3 relative to each other.

Unlike hard coatings, soft coatings do not attach well to sealant 7. Therefore, it is known in the art to prevent coatings 2, 4 to extend fully underneath spacer frame 5. For example, FIG. 1A illustrates that coatings 2, 4 extend halfway underneath spacer 5. This allows sufficient attachment between sealant 7 and glass bodies 1, 3.

WO2008/041848 discloses a strip assembly comprising a first translucent substrate comprising a first body, a second translucent substrate comprising a second body and arranged spaced apart from the first substrate, and a plurality of strips arranged in between the first and second substrate, each strip having one end thereof hingedly connected to the second substrate. The assembly further comprises a first electrode being spaced apart from the strips and configured for receiving an electrostatic charge for charging the first electrode, and a second electrode connected to the strips and configured for receiving an electrostatic charge for charging the strips.

Each strip is configured to pivot relative to the second substrate under the influence of an electrostatic force that is generated by the electrostatic charges on the strips and the first electrode, thereby changing the translucence of the assembly.

The strip assembly can for instance be used to manufacture an insulated glazing with integrated blinds. In this case, the translucence of the insulated glazing can be adjusted in dependence of the voltage that is applied between the first and second electrodes. Depending on the arrangement of the electrodes and the strips, the insulated glass unit can be configured to be in a substantially transparent state when no voltage is applied or in a substantiality opaque state when a voltage is applied, or vice versa. The skilled person readily understands that the amount of transparency or opacity can be chosen as desired.

When trying to implement the known strip assembly in insulated glazing, a difficulty arises in that an electrical connection has to be made between the electrodes, which reside within the airtight cavity, and the outside.

According to the invention, this problem is solved using the insulated glazing as defined in claim 1 which comprises a first translucent substrate, comprising a first body and a first coating covering said first body, and a second translucent substrate comprising a second body and a second coating covering said second body. As an example, a glass panel can be used as the first and second bodies.

The glazing further comprises a plurality of strips arranged in between the first and second substrate, each strip having one end thereof hingedly connected to the second substrate, and a spacer frame arranged in a peripheral region of the first and second substrate, and configured to provide a spacing between the first and second substrates.

The first and second coatings are soft low-emissivity coatings and a sealant is arranged in between the spacer frame and the second substrate and in between the spacer frame and the first substrate. The space frame and sealant define an at least substantially airtight cavity.

The first coating forms a first electrode configured for receiving an electrostatic charge for charging the first electrode, and the second coating forms a second electrode configured for receiving an electrostatic charge for charging the strips. Each strip is configured to pivot relative to the second substrate under the influence of an electrostatic force that is generated by the electrostatic charges on the strips and the first electrode, thereby changing the translucence and/or color of the assembly.

According to the invention, the insulated glazing further comprises a first and second connecting strip that extend at least partially underneath the spacer frame and that electrically contacts the first and second coating, respectively. Furthermore, the glazing comprises a first and second electrical terminal that is electrically connected to the first and second connecting strip, respectively.

The electrical contact between the first and/or second connecting strip and the first and/or second coating, respectively, can be achieved by a fixed connection, e.g. using conductive glue. Alternatively, such contact can be realized by mechanical pressure. For example, the strips can be pressed onto the relevant coating by the spacer frame and/or sealant.

The applicant has found that the limited conductivity of low-e coatings is acceptable for actuating the strips inside the cavity. This is mainly due to the low currents and high voltages that are applied, typically above 2 kV. By making use of the first and second coatings as the first and second electrodes, respectively, and by using first and second connecting strips, it becomes possible to realize an electrical connection to the electrodes inside the cavity from outside the cavity without requiring additional connectors or dedicated wiring. Moreover, application of the first and second connecting strips is compatible with known insulated glazing assembly processes and thereby provides a high level of product reliability.

The first and second coatings may each extend only partially underneath the spacer frame. In this case, the sealant near the first and second connecting strips may be arranged in between the spacer frame and the first and second connecting strip, respectively. To this end, it is advantageous if the electrical conductivity of the first and second connecting strip is adequate and if the adhesion to the sealant is sufficient to effectively form an electrical connection between the area inside the cavity and outside the cavity without deteriorating the sealing of the cavity.

The first and second connecting strips may each extend fully underneath the spacer frame. In an embodiment, the connecting strips contact the corresponding coatings underneath the spacer frame such that the optical appearance of the glazing, which is mainly determined by the cavity region, does not substantially change. For example, the connecting strips may be arranged such that they do not significantly extend beyond the spacer frame into the cavity.

The first and/or second connecting strip may be an elongated strip, preferably extending substantially perpendicular to the spacer frame. The strip may be very small when compared to the spacer frame as electrical contact need only be made at one or a few points on the glazing panel.

The insulated glazing may comprise an insulation layer covering the first coating, wherein the insulation layer has been removed at the position of the first connecting strip to allow electrical contact between the first coating and the first connecting strip. The insulation layer prevents or limits electrical discharge from occurring between the end of the strips and the first electrode inside the cavity.

The soft coating may comprise at least one material from the group of materials consisting of metals, metal oxides such as SnO₂, and metal nitrides. Furthermore, the insulated glazing may further comprise a kit, caulk, cement, or glue arranged outside the cavity and fixedly attaching the first and second substrates to each other.

According to a second aspect, the invention provides an insulated glazing that comprises a first translucent substrate comprising a first body and a first coating covering said first body, and a second translucent substrate comprising a second body and a second coating covering said second body. The glazing further comprises a plurality of strips arranged in between the first and second substrate, each strip having one end thereof hingedly connected to the second substrate, and a spacer frame arranged in a peripheral region of the first and second substrate, and configured to provide a spacing between the first and second substrates, wherein the first and second coatings are hard low-emissivity coatings.

A sealant is arranged in between the spacer frame and the second substrate and in between the spacer frame and the first substrate, wherein the spacer frame and sealant define an at least substantially airtight cavity. The first coating forms a first electrode that is configured for receiving an electrostatic charge for charging the first electrode, and the second coating forms a second electrode that is configured for receiving an electrostatic charge for charging the strips.

Each strip is configured to pivot relative to the second substrate under the influence of an electrostatic force that is generated by the electrostatic charges on the strips and the first electrode, thereby changing the translucence and/or color of the assembly.

According to this second aspect of the invention, the first and second coatings extend from inside the cavity to outside the cavity, beyond the spacer frame. The insulated glazing further comprises a first electrical terminal and a second electrical terminal that are electrically connected to the first and second coating, respectively, outside the cavity.

The glazing may further comprise an insulation layer covering the first coating, wherein the insulation layer has been removed at the position of the first electrical terminal to allow electrical contact between the first coating and the first electrical terminal, respectively. Similar to the glazing according to the first aspect of the invention, the insulation layer prevents or limits electrical discharge from occurring inside the cavity.

The hard coating may comprise a metallic oxide such as SnO₂, optionally with additives. In addition, a kit, caulk, cement, or glue may be arranged outside the cavity, fixedly attaching the first and second substrates to each other.

According to a further aspect of the invention, a method for manufacturing insulated glazing having soft-coating is provided that comprises the steps of:

providing the second substrate;

arranging the plurality of strips on the second substrate, each strip having one end thereof hingedly connected to the second substrate;

providing the second connecting strip and electrically connecting the second connecting strip to the second coating;

providing the spacer frame having the sealant arranged on a top and bottom side;

placing the spacer frame on the second substrate such that the second connecting strip extends at least partially underneath the spacer frame;

providing the first substrate;

providing the first connecting strip and electrically connecting the first connecting strip to the first coating;

arranging the first substrate on the spacer frame such that the first connecting strip extends at least partially underneath the spacer frame.

According to another further aspect of the invention, a method for manufacturing insulated glazing having hard-coating is provided that comprises the steps of:

providing the second substrate;

arranging the plurality of strips on the second substrate, each strip having one end thereof hingedly connected to the second substrate;

providing the second electrical terminal and electrically connecting the second electrical terminal to the second coating;

providing the spacer frame having the sealant arranged on a top and bottom side;

placing the spacer frame on the second substrate such that the second electrical terminal is arranged outside of the spacer frame;

providing the first substrate;

providing the first electrical terminal and electrically connecting the first electrical terminal to the first coating;

arranging the first substrate on the spacer frame such that the first electrical terminal is arranged outside of the spacer frame.

Next, the present invention will be described in more detail referring to the appended. drawings, wherein:

FIGS. 1A and 1B illustrate a known insulated glazing;

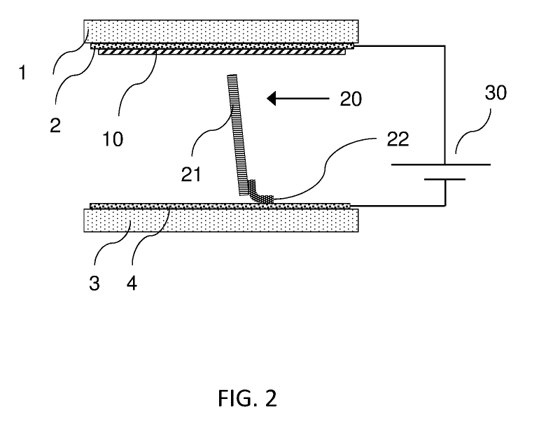

FIG. 2 illustrates an operation of the insulated panel according to the invention;

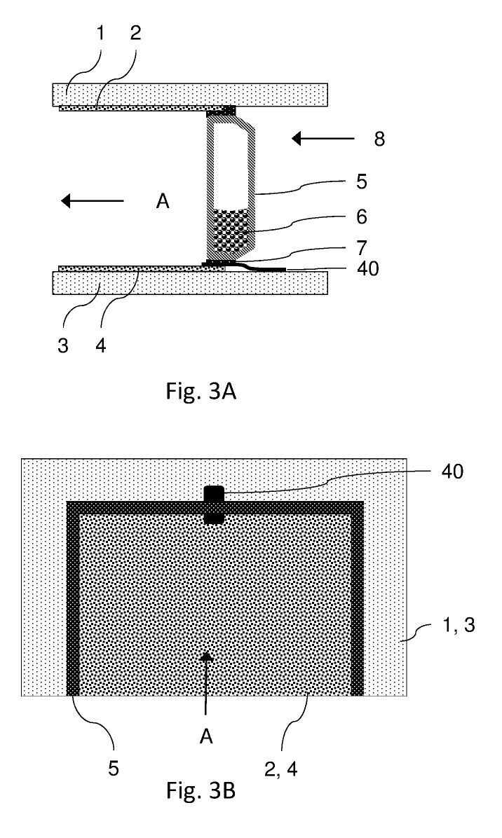

FIGS. 3A and 3B illustrate a first embodiment of the invention; and

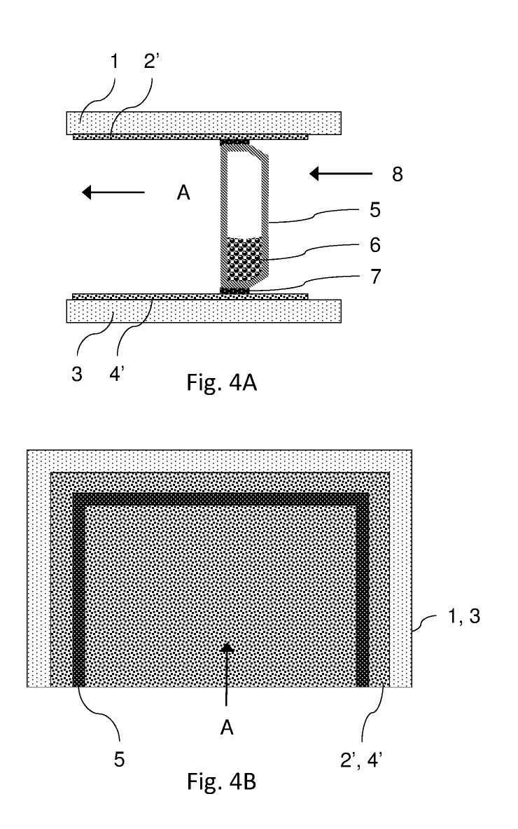

FIGS. 4A and 4B illustrate a second embodiment of the invention.

FIG. 2 illustrates an operation of the insulated panel according to the invention. The panel comprises a first translucent substrate comprising a first glass body 1, a second translucent substrate comprising a second glass body 3 and arranged spaced apart from first substrate 1, and a plurality of strips 20 arranged in between first substrate 1 and second substrate 3, each strip 20 having one end thereof hingedly connected to second substrate 3. The panel further comprises a first electrode 2 formed by a low-e coating and being spaced apart from strips 20 and configured for receiving an electrostatic charge for charging first electrode 2, and a second electrode 4 formed by a low-e coating and connected to strips 20 and configured for receiving an electrostatic charge for charging strips 20.

Each strip 20 is configured to pivot relative to second substrate 3 under the influence of an electrostatic force that is generated by the electrostatic charges on strips 20 and first electrode 2, thereby changing the translucence of the assembly. Strips 20 each comprise a rigid slat part 21 and a hinge part 22 that enables the pivoting of slat part 21. It should be noted that a plurality of strips 20 is arranged in between the first and second bodies 1, 3 of which only one strip is shown.

In FIG. 2, an insulating layer 10 is optionally arranged on top of first electrode 2 to reduce the chances of electrical discharge between the top of strips 20 and first electrode 2. Also shown is a high voltage source 30 for charging slat part 21 via second electrode 4 and for charging first electrode 2. During operation, the angle under which slat part 21 is orientated relative to second substrate 3 is determined by the voltage applied by voltage source 30.

FIGS. 3A and 3B illustrate a first embodiment of the invention. More in particular, FIG. 3A shows a cross section of an edge region of the panel, whereas FIG. 3B illustrates a top view. The inner region of the panel can be arranged as illustrated in FIG. 2A.

FIG. 3A illustrates a glazing panel in which the first glass body 1 is covered by a soft-coating 2 and in which the second glass body 3 is covered by a soft-coating 4. For example, coatings 2, 4 could comprise any of the materials from the group consisting of metals, metal oxides such as SnO₂, and metal nitrides.

As shown in FIG. 3A, coatings 2, 4 extend to roughly halfway underneath spacer frame 5. Unlike the embodiment in FIG. 1A, a second connecting strip 40 is arranged between second coating 4 and spacer frame 5. A sealant 7 is used to obtain an airtight cavity in the region indicated by arrow A.

At the location indicated by arrow 8, a kit or other adhesive is used to fixedly connect glass bodies 1, 3 to each other.

Second connecting strip 40 is electrically connected to second coating 4. For example, connecting strip 40 is glued, using electrically conducting glue, to second coating 4. Alternatively, the electrical connection is realized by the mechanical pressure exerted by spacer frame 5 that presses down on connecting strip 40.

As shown in FIG. 3B, second connecting strip 40 is elongated in a first direction that is substantially perpendicular to spacer frame 8. Moreover, although only a single connecting strip 40 is shown, the present invention does not exclude the use of several separated connecting strips 40.

FIG. 3A only shows a second connecting strip 40. An identical strip can be arranged on the top side. Such connecting strip could be used to provide an electrical connection to first coating 2.

Electrical terminals can be formed on the connecting strips. For example, the electrical terminals can be shaped as connectors allowing a wired connection to a high voltage source. The skilled person readily understands that the electrical terminals can be formed in many different ways.

FIGS. 4A and 4B illustrate a second embodiment of the invention. More in particular, FIG. 4A shows a cross section of an edge region of the panel, whereas FIG. 4B illustrates a top view. The inner region of the panel can be arranged as illustrated in FIG. 2A.

FIG. 4A illustrates a glazing panel in which the first glass body 1 is covered by a hard-coating 2′ and in which the second glass body 3 is covered by a hard-coating 4′. For example, coatings 2′, 4′ could comprise a thin tin oxide.

As shown in FIG. 4A, coatings 2′, 4′ extend nearly to the edge of the panel. Near the edge, coatings 2′, 4′ have been etched away to avoid the occurrence of high voltages near the edge of the panel in a region that can be touched by a user.

Unlike the embodiment in FIG. 3A, sealant 7 is arranged between spacer frame 5 and coatings 2′, 4′. Similar to FIG. 3A, at the location indicated by arrow 8, a kit or other adhesive is used to fixedly connect glass bodies 1, 3 to each other.

Electrical terminals can be formed directly on coatings 2′, 4′. As stated before, the electrical terminals can be shaped as connectors allowing a wired connection to a high voltage source.

In the embodiments in FIGS. 3A and 4A, first coating 2, 2′ may be covered by an insulation layer as shown in FIG. 2A. This latter layer can be locally etched at the position where first coating 2 should be connected to a connecting strip, as in FIG. 3A, or where first coating 2′ should be connected to an electrical terminal, as in FIG. 4A.

It should be appreciated by the skilled person that although the present invention has been described using detailed embodiments thereof, the invention is not limited to these embodiments but various modifications can be implemented without departing from the scope of the invention which is defined by the appended claims.

1. An insulated glazing, comprising:
a first translucent substrate comprising a first body and a first coating covering said first body;
a second translucent substrate comprising a second body and a second coating covering said second body;
a plurality of strips arranged in between the first and second substrate, each strip having one end thereof hingedly connected to the second substrate;
a spacer frame arranged in a peripheral region of the first and second substrates, and configured to provide a spacing between the first and second substrates, wherein the first and second coatings are soft low-emissivity coatings;
a sealant arranged in between the spacer frame and the second substrate and in between the spacer frame and the first substrate, said spacer frame and sealant defining at least a substantially airtight cavity;
wherein the first coating forms a first electrode configured for receiving an electrostatic charge for charging the first electrode, and wherein the second coating forms a second electrode configured for receiving an electrostatic charge for charging the strips;
wherein each strip is configured to pivot relative to the second substrate under the influence of an electrostatic force that is generated by the electrostatic charges on the strips and the first electrode, thereby changing at least one of the translucence and the color of the assembly;
the insulated glazing further comprising:
a first and second connecting strip extending at least partially underneath the spacer frame and electrically contacting the first and second coating, respectively; and
a first and second electrical terminal that are electrically connected to the first and second connecting strip, respectively.

2. The insulated glazing of claim 1, wherein the first and second coatings each extend only partially underneath the spacer frame, and wherein the sealant near the first and second connecting strips is arranged in between the spacer frame and the first and second connecting strip, respectively.

3. The insulated glazing of claim 2, wherein the first and second connecting strips each extend fully underneath the spacer frame.

4. The insulated glazing of claim 1, wherein at least one of the first and second connecting strip is an elongated strip.

5. The insulated glazing of claim 1, further comprising an insulation layer covering the first coating, wherein the insulation layer has been removed at the position of the first connecting strip to allow electrical contact between the first coating and the first connecting strip.

6. The insulated glazing of claim 1, wherein the soft coating comprises at least one material from the group of materials consisting of metals, metal oxides, and metal nitrides.

7. The insulated glazing of claim 1, further comprising a kit, caulk, cement, or glue arranged outside the cavity and fixedly attaching the first and second substrates to each other.

8. An insulated glazing, comprising:
a first translucent substrate comprising a first body and a first coating covering said first body;
a second translucent substrate comprising a second body and a second coating covering said second body;
a plurality of strips arranged in between the first and second substrate, each strip having one end thereof hingedly connected to the second substrate;
a spacer frame arranged in a peripheral region of the first and second substrate, and configured to provide a spacing between the first and second substrates, wherein the first and second coatings are hard low-emissivity coatings; and
a sealant arranged in between the spacer frame and the second substrate and in between the spacer frame and the first substrate, said spacer frame and sealant defining at least a substantially airtight cavity;
wherein the first coating forms a first electrode configured for receiving an electrostatic charge for charging the first electrode, and wherein the second coating forms a second electrode configured for receiving an electrostatic charge for charging the strips;
wherein each strip is configured to pivot relative to the second substrate under the influence of an electrostatic force that is generated by the electrostatic charges on the strips and the first electrode, thereby changing at least one of the translucence and color of the assembly; and
wherein the first and second coating extend from inside the cavity to outside the cavity, beyond the spacer frame, the insulated glazing further comprising a first and second electrical terminal that are electrically connected to the first and second coating, respectively, outside the cavity.

9. The insulated glazing of claim 8, further comprising an insulation layer covering the first coating, wherein the insulation layer has been removed at the position of the first electrical terminal to allow electrical contact between the first coating and the first electrical terminal, respectively.

10. The insulated glazing of claim 8, wherein the hard coating comprises a metallic oxide.

11. The insulated glazing of claim 8, further comprising a kit, caulk, cement, or glue arranged outside the cavity and fixedly attaching the first and second substrates to each other.

12. A method for manufacturing the insulated glazing of claim 1, comprising:
providing the second substrate;
arranging the plurality of strips on the second substrate, each strip having one end thereof hingedly connected to the second substrate;
providing the second connecting strip and electrically connecting the second connecting strip to the second coating;
providing the spacer frame having the sealant arranged on a top and bottom side;
placing the spacer frame on the second substrate such that the second connecting strip extends at least partially underneath the spacer frame;
providing the first substrate;
providing the first connecting strip and electrically connecting the first connecting strip to the first coating; and
arranging the first substrate on the spacer frame such that the first connecting strip extends at least partially underneath the spacer frame.

13. A method for manufacturing the insulated glazing of claim 8, comprising:
providing the second substrate;
arranging the plurality of strips on the second substrate, each strip having one end thereof hingedly connected to the second substrate;
providing the second electrical terminal and electrically connecting the second electrical terminal to the second coating;
providing the spacer frame having the sealant arranged on a top and bottom side;
placing the spacer frame on the second substrate such that the second electrical terminal is arranged outside of the spacer frame;
providing the first substrate;
providing the first electrical terminal and electrically connecting the first electrical terminal to the first coating; and
arranging the first substrate on the spacer frame such that the first electrical terminal is arranged outside of the spacer frame.

14. The insulated glazing of claim 4, wherein at least one of the first and second connecting strips extends substantially perpendicular to the spacer frame.

15. The insulated glazing of claim 6, wherein the soft coating comprises SnO₂.

16. The insulated glazing of claim 10, wherein the hard coating comprises SnO₂.

17. The insulated glazing of claim 10, wherein the hard coating includes an additive.
